(19) United States
(12) Patent Application Publication
(10) Pub. No.: US 2023/0330893 A1
(43) Pub. Date: Oct. 19, 2023

(54) MULTIPLE BATTERY PACK POWER CUTTER DEVICE

(71) Applicant: Makita Corporation, Anjo-shi (JP)

(72) Inventors: Takuya SUMI, Anjo-shi (JP); Kenta Tominaga, Anjo-shi (JP); Sho Tsuda, Anjo-shi (JP)

(73) Assignee: Makita Corporation, Anjo-shi (JP)

(21) Appl. No.: 18/340,522

(22) Filed: Jun. 23, 2023

Related U.S. Application Data
(63) Continuation of application No. 17/016,637, filed on Sep. 10, 2020.

(30) Foreign Application Priority Data
Sep. 12, 2019 (JP) 2019-166619

(51) Int. Cl. B28D 1/04; B23D 47/12; B27B 9/00; B25F 5/02

(52) U.S. Cl. CPC B28D 1/04; B23D 47/12; B27B 9/00; B25F 5/02

(57) ABSTRACT

A power cutter disclosed herein may include: a disk blade; a body configured to rotatably support the disk blade about a rotation axis and comprising an electric motor for rotationally driving the disk blade; a plurality of battery packs detachably attached to the body and configured to supply electric power to the electric motor; a grip disposed on the body and configured to be gripped by a user; and a main switch disposed on the grip and configured to electrically connect the plurality of battery packs to the electric motor when the user activates the main switch; wherein a central axis of the grip extends along a reference plane which is perpendicular to the rotation axis of the disk blade, and a distance from the reference plane to the disk blade is less than or equal to 1.5 times a width of the grip.

### CROSS-REFERENCE TO RELATED APPLICATION

This application is a continuation application of U.S. patent application Ser. No. 17/016,637, filed on Sep. 10, 2020, which claims priority to Japanese patent application No. 2019-166619, filed on Sep. 12, 2019, the entire contents of which are incorporated herein by reference.

### TECHNICAL FIELD

The present disclosure relates to a power cutter, particularly a handheld power cutter.

### BACKGROUND

US Patent Application Publication No. 2017/0120436 describes a power cutter. This power cutter includes a disk blade, a body that rotatably supports the disk blade and includes an electric motor for rotationally driving the disk blade, and a battery pack that is detachably attached to the body and supply electric power to the electric motor.

### SUMMARY

Since a conventional power cutter uses a single battery pack, there may be a risk that output power or operating time of the power cutter is insufficient. Accordingly, the present disclosure provides an art configured to improve output power and/or operating time of a power cutter.

A power cutter is provided from an aspect of the art disclosed herein. The power cutter may comprise: a disk blade; a body configured to rotatably support the disk blade about a rotation axis and comprising an electric motor for rotationally driving the disk blade; a plurality of battery packs detachably attached to the body and configured to supply electric power to the electric motor; a grip disposed on the body and configured to be gripped by a user; and a main switch disposed on the grip and configured to electrically connect the plurality of battery packs to the electric motor when the user activates the main switch.

In the power cutter described above, the electric power can be supplied to the electric motor by the plurality of battery packs. Due to this, an output and/or operating time of the power cutter can be significantly increased. Here, the power cutter described herein refers to a power cutter in which a central axis of the grip extends along a reference plane which is perpendicular to the rotation axis of the disk blade, and a distance from the reference plane to the disk blade is less than or equal to 1.5 times a width of the grip. The disk blade may be positioned on the reference plane, and the distance from the reference plane to the disk blade may be zero.

On the other hand, when the plurality of battery packs is attached to the body, a weight of the power cutter greatly increases, by which user maneuverability of the power cutter may be degraded. To avoid this, in an embodiment of the art disclosed herein, a distance from the reference plane to a center of gravity of the power cutter may by less than or equal to 1.5 times the width of the grip. With such a configuration, the center of gravity of the power cutter is located close to the reference plane, by which a posture of the power cutter is easily stabilized when the user holds the power cutter by gripping the grip.

### BRIEF DESCRIPTION OF DRAWINGS

FIG. 1 shows a perspective view of an outer appearance of a power cutter 10 of a first embodiment.

FIG. 2 shows a perspective view of the outer appearance of the power cutter 10 of the first embodiment with a battery pack cover 22 opened.

FIG. 3 shows a side view of the outer appearance of the power cutter 10 of the first embodiment.

FIG. 4 shows a plan view of the outer appearance of the power cutter 10 of the first embodiment.

FIG. 5 shows a circuit diagram showing an electrical configuration of the power cutter 10 of the first embodiment.

FIG. 6 shows a plan view for explaining a weight distribution in the power cutter 10 of the first embodiment.

FIG. 7 shows a side view of an outer appearance of a power cutter 110 of a second embodiment.

FIG. 8 shows a plan view of the outer appearance of the power cutter 110 of the second embodiment.

FIG. 9 shows a side view of an outer appearance of a power cutter 210 of a third embodiment.

FIG. 10 shows a plan view of the outer appearance of the power cutter 210 of the third embodiment.

### DETAILED DESCRIPTION

In one embodiment of the art disclosed herein, the plurality of battery packs may comprise at least a first battery pack and a second battery pack. In this case, a center of gravity of the first battery pack may be located on one side of the reference plane and a center of gravity of the second battery pack may be located on another side of the reference plane. With such a configuration, a center of gravity of the power cutter including the plurality of battery packs can be arranged close to the reference plane even when a weight of each of the battery packs is relatively large.

In one embodiment of the art disclosed herein, a distance from the reference plane to the center of gravity of the first battery pack may be greater than 1.5 times the width of the grip. According to such a configuration, the center of gravity of the first battery pack is located relatively far from the reference plane, by which moment of inertia of the power cutter increases. Due to this, a posture of the power cutter is easily stabilized against an exterior force such as a reaction force from an object to be cut.

In addition to the above, a distance from the reference plane to the center of gravity of the second battery pack may also be greater than 1.5 times the width of the grip. According to such a configuration, the moment of inertia of the power cutter is further increased, by which the posture of the power cutter is more easily stabilized.

In one embodiment of the art disclosed herein, a distance from the reference plane to the center of gravity of the first battery pack may be equal to a distance from the reference plane to the center of gravity of the second battery pack. According to such a configuration, the center of gravity of the power cutter including the plurality of battery packs is easily arranged close to the reference plane. A weight of the first battery pack may be the same as or different from a weight of the second battery pack.

In the above embodiment, the first battery pack and the second battery pack may be arranged symmetrically with respect to the reference plane. It should be noted, as another embodiment, the first battery pack and the second battery pack may be arranged asymmetrically about the reference plane by giving consideration for example to a position of the center of gravity of the body.

In one embodiment of the art disclosed herein, each of centers of gravity of all of the plurality of the battery packs may be located within a distance from the reference plane, the distance being less than or equal to 1.5 times the width of the grip. According to such a configuration, a change in a location of the center of gravity of the power cutter caused by a change in the number of the battery packs attached to the body can be suppressed. Accordingly, regardless of the number of the battery packs attached to the body, the posture of the power cutter is easily stabilized when the user holds the power cutter by gripping the grip.

In one embodiment of the art disclosed herein, the disk blade may be located at a front portion of the body, and the grip may be located at a rear portion of the body. In this case, the electric motor may be located between the disk blade and the grip.

In one embodiment of the art disclosed herein, the body may comprise an openable cover configured to cover the plurality of battery packs. According to such a configuration, the plurality of battery packs attached to the body can be protected from moisture and dust.

In one embodiment of the art disclosed herein, each of the plurality of battery packs may be configured to be attached to the body from above the body and detached upward from the body. According to such a configuration, the user can easily detach each of the battery packs relative to the body in a state where the power cutter is placed on a ground surface.

In one embodiment of the art disclosed herein, the body may be configured to electrically connect at least two of the plurality of battery packs in series. According to such a configuration, output power of the power cutter can be increased.

In one embodiment of the art disclosed herein, the body may be configured to electrically connect at least two of the plurality of battery packs in parallel. According to such a configuration, an operating time of the power cutter can be made longer.

In an aspect of the art disclosed herein, the distance from the reference plane to the disk blade may be less than the width of the rear grip. According to such a configuration, since the disk blade is located even closer to the reference plane of the grip, the user can easily hold the power cutter in a stable manner against the reaction force applied to the disk blade.

In one embodiment of the art disclosed herein, a distance from the reference plane to a center of gravity of the power cutter may be less than the width of the grip. According to such a configuration, since the center of gravity of the power cutter is located even closer to the reference plane of the grip, the posture of the power cutter is easily stabilized when the user holds the power cutter by gripping the grip.

Representative, non-limiting examples of the present disclosure will now be described in further detail with reference to the attached drawings. This detailed description is merely intended to teach a person of skill in the art further details for practicing aspects of the present teachings and is not intended to limit the scope of the present disclosure. Furthermore, each of the additional features and teachings disclosed below may be utilized separately or in conjunction with other features and teachings to provide improved power cutters, as well as methods for using and manufacturing the same.

Moreover, combinations of features and steps disclosed in the following detailed description may not be necessary to practice the present disclosure in the broadest sense, and are instead taught merely to particularly describe representative examples of the present disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### DETAILED DESCRIPTION

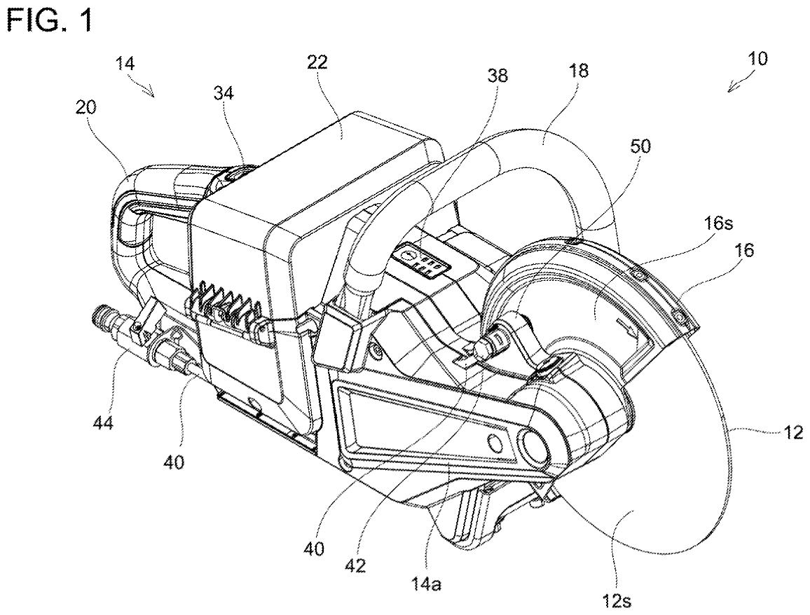

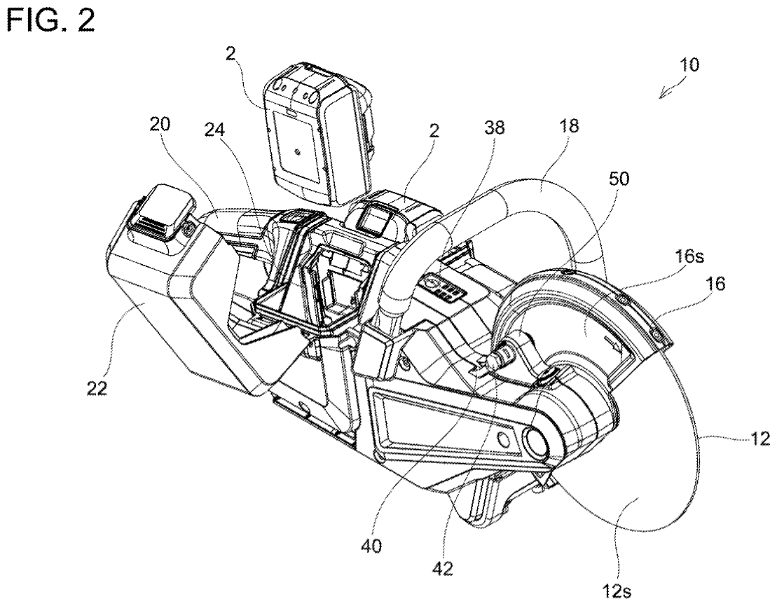

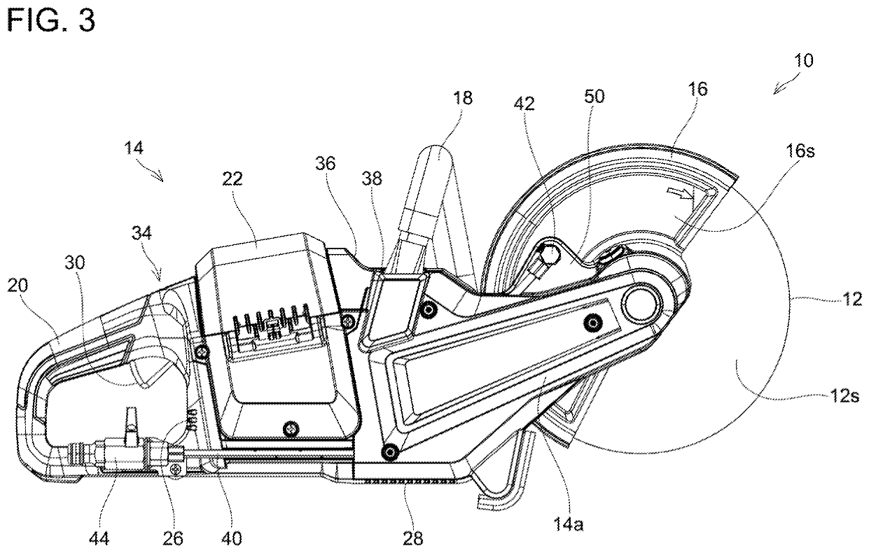

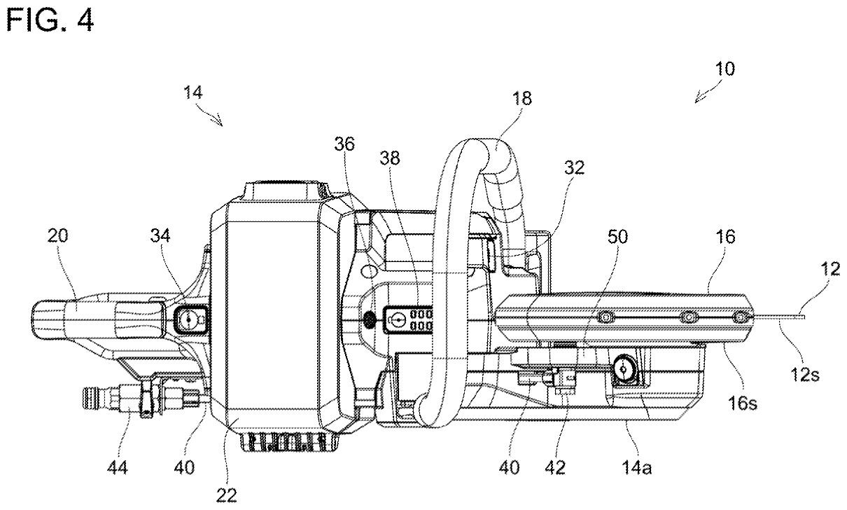

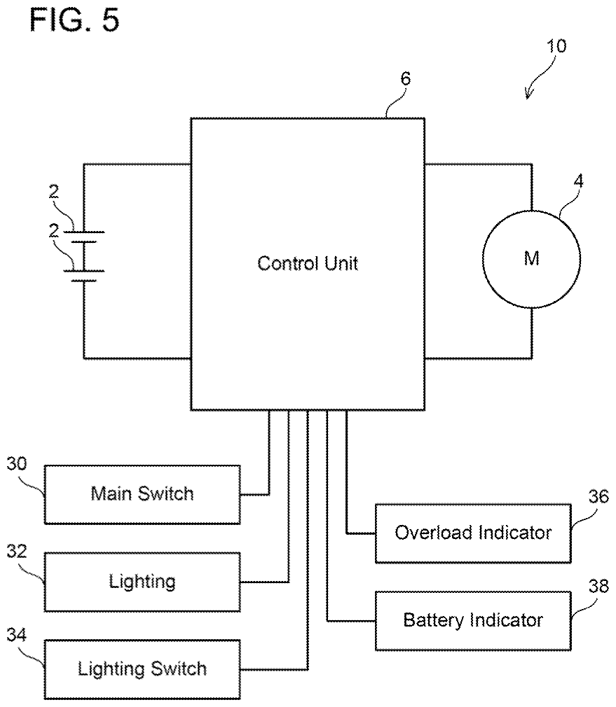

(First Embodiment) A power cutter 10 of the first embodiment will be described with reference to the figures. The power cutter 10 is a handheld working machine and used to cut an object to be cut, mainly stones and steels. As shown in FIGS. 1 to 5, the power cutter 10 comprises a disk blade 12 and a body 14 configured to rotatably support the disk blade 12. The body 14 comprises an electric motor 4 for rotationally driving the disk blade 12 and a control unit 6 configured to control the electric motor 4 (see FIG. 5). The control unit 6 includes a power conversion circuit and a microprocessor, for example. The electric motor 4 is disposed within the body 14 and connected to the disk blade 12 via, for example, a transmission belt (not shown). A transmission mechanism configured to transmit power of the electric motor 4 to the disk blade 12 may be configured only of rigid parts such as gears and rods, and may be configured beltless.

The disk blade 12 is a blade with a disk shape, and includes a plurality of blade edges or abrasive wheels at its outer peripheral edge. The disk blade 12 may be a diamond wheel, for example. Since the disk blade 12 is a so-called consumable article, it is detachably attached to the body 14. Although not particularly limited, the disk blade 12 it attached to a blade arm 14a of the body 14. The blade arm 14a extends frontward from the body 14, and the disk blade 12 is positioned at a tip of the blade arm 14a. A rotation axis of the disk blade 12 extends perpendicular to a longitudinal direction of the blade arm 14a.

The power cutter 10 further comprises a plurality of battery packs 2. Each of the battery packs 2 includes at least one secondary battery cell. A plurality of battery interfaces 24 is disposed on the body 14. Each of the battery interfaces 24 detachably receives one of the plurality of battery packs 2. Due to this, the plurality of battery packs 2 is detachably attached to the body 14 and supplies electric power to the electric motor 4. The body 14 further includes a battery pack cover 22. The battery pack cover 22 is an openable cover and configured to cover the plurality of battery packs 2 attached to the battery interfaces 24. Due to this, the plurality of battery packs 2 is protected from moisture and dust. As shown in FIG. 5, the body 14 is configured to connect the plurality of battery packs 2 in series, and the plurality of battery packs 2 connected in series is electrically connected to the electric motor 4 via the control unit 6. As another embodiment, the body 14 may be configured to connect the plurality of batter packs 2 in parallel.

The power cutter 10 further includes a blade cover 16. The blade cover 16 is assembled to the body 14 and covers a part of the disk blade 12. The blade cover 16 prevents dust generated by operation of the disk blade 12 from scattering toward the user. A specific configuration of the blade cover 16 is not particularly limited. Although it is an example, the blade cover 16 of the present embodiment is attached to the tip of the blade arm 14a and configured to cover a part of the disk blade 12 in a circumferential direction thereof (e.g., an angle range greater than or equal to 150 degrees). At least a part of the blade cover 16 may be movable relative to the body 14.

The power cutter 10 further includes a water supply hose 40. The water supply hose 40 is assembled to the body 14, and configured to supply water into the blade cover 16. A tip end of the water supply hose 40 is connected to a hose end holder 50 of the body 14 via a plug 42. Although not particularly limited, the hose end holder 50 is disposed on the blade arm 14a, and is adjacent to the blade cover 16. A water supply connector 44 is disposed at abase end of the water supply hose 40. The water supply connector 44 is held by the body 14, and connected to an external water supply source such as a faucet for tap water via a hose that is not shown.

The power cutter 10 further comprises a front grip 18 and a rear grip 20. The front grip 18 and the rear grip 20 are both disposed on the body 14. The front grip 18 is located at a front portion of the body 14, and extends lateralward from above the body 14. The rear grip 20 is located at a rear portion of the body 14, and extends rearward from the body 14. Typically, the user holds the power cutter 10 by gripping the front grip 18 with his/her left hand and gripping the rear grip 20 with his/her right hand. At this time, the user can adjust a posture of the power cutter 10 by changing a position to grip the front grip 18. A main switch 30 is disposed on the rear grip 20. When the user activates the main switch 30, the plurality of battery packs 2 is electrically connected to the electric motor 4 via the control unit 6. Due to this, the electric motor 4 drives the disk blade 12. When the user deactivates the main switch 30, the plurality of battery packs 2 is electrically disconnected from the electric motor 4, and the electric motor 4 stops driving the disk blade 12.

The power cutter 10 further includes a lighting 32 and a lighting switch 34 to turn on and off the lighting 32. Although not particularly limited, the lighting 32 and the lighting switch 34 are disposed on the body 14. The lighting 32 is located at the front portion of the body 14, and irradiates the disk blade 12 and the object to be cut. Although this is an example, the lighting 32 of the present embodiment is configured by using at least one light-emitting diode. The lighting switch 34 is located on an upper surface of the rear grip 20 and configured such that the user can operate the lighting switch 34 while holding the rear grip 20.

The power cutter 10 further includes an overload indicator 36 and a battery indicator 38. The overload indicator 36 is a notifier configured to notify the user of an overload applied to the disk blade 12. Although not particularly limited, the overload indicator of the present embodiment includes at least one light-emitting diode and causes the light-emitting diode to turn on when a load applied to the disk blade 12 exceeds a predetermined value. The user typically adjusts the force pressing the disk blade 12 against the object to be cut while monitoring the overload indicator 36. Due to this, the overload indicator 36 may be disposed at a position where the user using the power cutter 10 can easily check the overload indicator 36. The battery indicator 38 is a notifier configured to notify the user of a charge level of each of the plurality of battery packs 2. Although not particularly limited, the battery indicator 38 of the present embodiment includes a plurality of light-emitting diodes for each of the battery packs 2, and configured to change the number of the light-emitting diodes to be turned on in accordance with the charge level of each of the battery packs 2.

The power cutter 10 further includes a suction port 26 and an exhaust port 28. The suction port 26 and the exhaust port 28 are disposed in the body 14, and configured to introduce cooling air into the body 14. The suction port 26 is located at the rear portion of the body 14, while the exhaust port 28 is located at the front portion of the body 14. In other words, a distance from the suction port 26 to the disk blade 12 is greater than a distance from the exhaust port 28 to the disk blade 12. As such, when the suction port 26 is located far from the disk blade 12, the dust generated by the operation of the disk blade 12 can be prevented from entering the body 14. On the other hand, the exhaust port 28 may be located close to the disk blade 12, and the cooling air can be circulated within the body 14 in a broader range by arranging the suction port 26 and the exhaust port 28 far from each other.

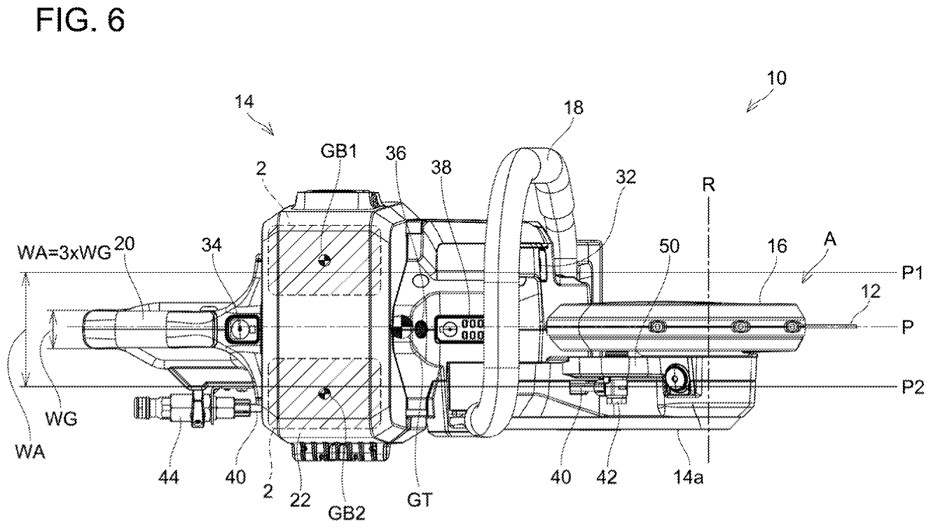

As shown in FIG. 6, in the power cutter 10 of the present embodiment, the central axis of the rear grip 20 extends along a reference plane P that is perpendicular to the rotation axis R of the disk blade 12, and the disk blade 12 is also located on the reference plane P. In other words, both of the disk blade 12 and the central axis of the rear grip 20 are located on the reference plane P that is perpendicular to the rotation axis R. According to such a configuration, the user holding the rear grip 20 can easily receive the reaction force applied to the disk blade 12 from the object to be cut. As another embodiment, however, the disk blade 12 may not necessarily be located on the reference plane P and may only be located within a central region A shown in FIG. 6. The central region A herein is a region having a width WA that is three times a width WG of the rear grip 20 with the reference plane P as the center thereof.

In FIG. 6, two planes P1, P2 show boundaries of the central region A. The two planes P1, P2 are parallel to the reference plane P, and one plane P1 is located on one side with respect to the reference plane P while the other plane P2 is located on another side with respect to the reference plane P. As described above, the width WA of the central region A is three times the width WG of the rear grip 20. Accordingly, a distance from the reference plane P to each of the planes P1, P2 is equal to 1.5 times the width WG of the rear grip 20. In other words, when the disk blade 12 is located within the central region A, the distance from the reference plane P to the disk blade 12 is less than or equal to 1.5 times the width WG of the rear grip 20. The disk blade 12 is typically located at the front portion of the body 14, and the rear grip 20 is located at the rear portion of the body 14. The electric motor 4 is located between the disk blade 12 and the rear grip 20 on the reference plane P.

The power cutter 10 of the present embodiment cuts the object to be cut, such as stones and steels, by rotationally operating the disk blade 12 with the electric motor 4. In doing so, the electric power having a relatively high-voltage is supplied to the electric motor 4 by the plurality of battery packs 2 connected in series. Due to this, the output power of the power cutter 10 is greatly improved. The power cutter 10 may, not limited to the two battery packs 2, comprise the larger number of battery packs. However, when the plurality of battery packs 2 is attached to the body 14, a weight of the power cutter 10 greatly increases, by which the user maneuverability of the power cutter 10 may be degraded. To avoid this, the power cutter 10 of the present embodiment is designed such that a distance from the reference plane P to a center of gravity GT of the power cutter 10 is less than or equal to 1.5 times the width WG of the rear grip 20. In other words, the center of gravity GT of the power cutter 10 is located within the central region A. According to such a configuration, due to the center of gravity GT of the power cutter 10 being located close to the reference plane P, the posture of the power cutter 10 is easily stabilized when the user holds the power cutter 10 by gripping the rear grip 20.

In the power cutter 10 of the present embodiment, a center of gravity GB1 of the one of the battery packs 2 is located on one side of the reference plane P while a center of gravity GB2 of the other of the battery packs 2 is located on another side of the reference plane P. In other words, the centers of gravity GB1, GB2 of the two battery packs 2 are distributed on both sides of the reference plane P. According to such a configuration, the center of gravity GT of the power cutter 10 including the plurality of battery packs 2 can be arranged close to the reference plane P even when a weight of each of the plurality of battery packs 2 is relatively large.

In the power cutter 10 of the present embodiment, a distance from the reference plane P to each of the centers of gravity GB1, GB2 of the battery packs 2 is greater than 1.5 times the width of the grip. In other words, the centers of gravity GB1, GB2 of respective battery packs 2 are located outside the central region A. According to such a configuration, moment of inertia of the power cutter 10 increases due to the centers of gravity GB1, GB2 of respective battery packs 2 being located relatively far from the reference plane P. Due to this, the posture of the power cutter 10 is easily stabilized against an exterior force such as the reaction force from the object to be cut. As another embodiment, only one of the centers of gravity GB1, GB2 of the two battery packs 2 may be located outside the central region A.

In the power cutter 10 of the present embodiment, the distance from the reference plane P to the center of gravity GB1 of the one of the battery packs 2 is equal to the distance from the reference plane P to the center of gravity GB2 of the other of the battery packs 2. According to such a configuration, the center of gravity GT of the power cutter 10 including the plurality of battery packs 2 is easily arranged close to the reference plane P. The weights of the two battery packs 2 may be equal to or different from each other.

In the power cutter 10 of the present embodiment, the two battery packs 2 are arranged symmetrically with respect to the reference plane P. It should be noted, as another embodiment, that the two battery packs 2 may be arranged asymmetrically with respect to the reference plane P by giving consideration for example to the position of the center of gravity GT of the body 14.

In the power cutter 10 of the present embodiment, each of the plurality of battery packs 2 is configured to be attached to the body 14 from above the body 14 and detached upward from the body 14. According to such a configuration, the user can easily detach each of the battery packs 2 relative to the body 14 in a state where the power cutter 10 is placed on a ground surface.

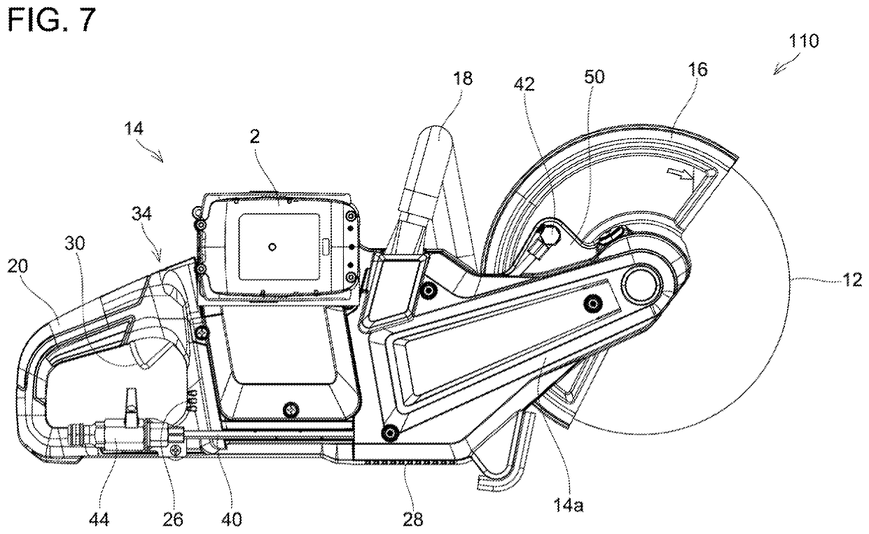

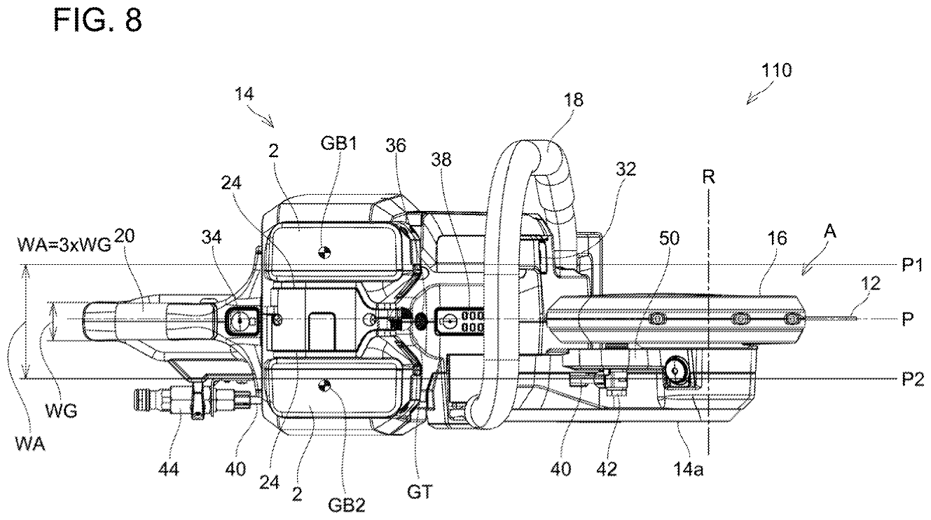

(Second Embodiment) A power cutter 110 of a second embodiment will be described with reference to FIGS. 7, 8. In the power cutter 110 of the second embodiment, the positions of the plurality of battery packs 2 are changed as compared to the power cutter 10 of the first embodiment. Hereafter, differences from the power cutter 10 of the first embodiment will be mainly described. The same reference signs are assigned in FIGS. 7, 8 to components identical with or corresponding to those of the first embodiment, and redundant explanations are omitted by incorporating the explanations described in the first embodiment.

In the power cutter 110 of the second embodiment, the two battery packs 2 are attached to an upper portion of the body 14. Each of the plurality of battery packs 2 is attached to the body 14 from the rear side, and detached from the body 14 to the rear side. According to such a configuration, the user can easily detach each of the battery packs 2 relative to the body 14 in a state where the power cutter 110 is placed on the ground surface.

In the power cutter 110 of the present embodiment as well, the distance from the reference plane P to a center of gravity GT of the power cutter 110 is designed to be less than or equal to 1.5 times the width WG of the rear grip 20. In other words, the center of gravity GT of the power cutter 110 is located within the central region A. The center of gravity GB1 of one of the battery packs 2 is located on the one side of the reference plane P, and the center of gravity GB2 of the other of the battery packs 2 is located on the other side of the reference plane P. The two battery packs 2 are arranged symmetrical with respect to the reference plane P, and the distance from the reference plane P to the center of gravity GB1 of the one of the battery packs 2 is equal to the distance from the reference plane P to the center of gravity GB2 of the other of the battery packs 2. The distance from the reference plane P to each of the centers of gravity GB1, GB2 of the battery packs 2 is greater than 1.5 times the width of the grip. In other words, each of the centers of gravity GB1, GB2 of the battery packs 2 is located outside the central region A.

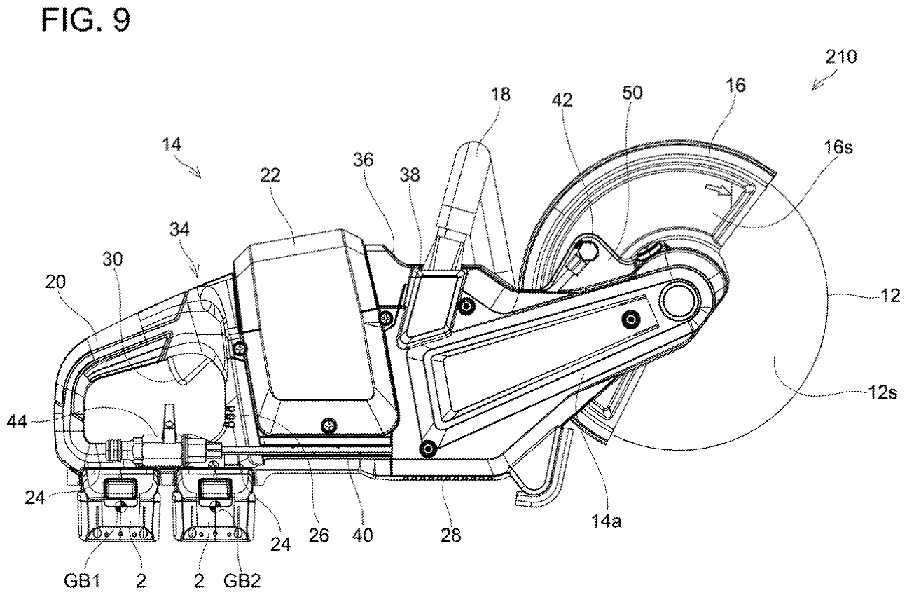

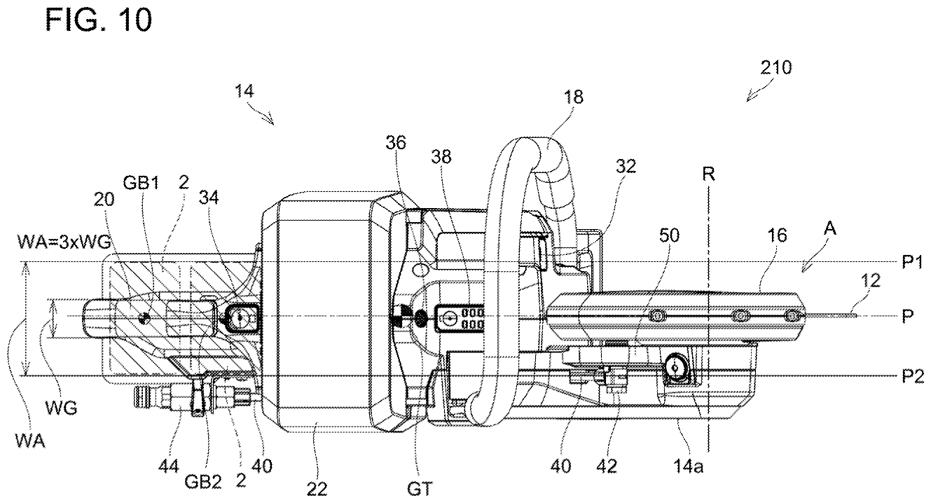

(Third Embodiment) A power cutter 210 of a third embodiment will be described with reference to FIGS. 9, 10. In the power cutter 210 of the third embodiment, the positions of the plurality of battery packs 2 are changed as compared to the power cutter 10 of the first embodiment. Hereafter, differences from the power cutter 10 of the first embodiment will be mainly described. The same reference signs are assigned in FIGS. 9, 10 to components identical with or corresponding to those of the first embodiment, and redundant explanations are omitted by incorporating the explanations described in the first embodiment.

In the power cutter 210 of the third embodiment, the two battery packs 2 are attached to a lower portion of the body 14. According to such a configuration, a posture of the power cutter 210 in use is easily stabilized due to the weights of the two battery packs 2. Each of the plurality of battery packs 2 is attached to the body 14 from a lateral side of the body 14, and detached to the lateral side from the body 14.

In the power cutter 210 of the present embodiment as well, the distance from the reference plane P to a center of gravity GT of the power cutter 210 is designed to be less than or equal to 1.5 times the width of the rear grip 20. In other words, the center of gravity GT of the power cutter 210 is located within the central region A. It should be noted that, unlike the first and second embodiments, the centers of gravity GB1, GB2 of the two battery packs 2 are located within the central region A, especially located substantially on the reference plane P. According to such a configuration, the center of gravity GT of the power cutter 210 including the plurality of battery packs 2 is easily disposed close to the reference plane P. The weights of the two battery packs 2 may be equal to or different from one another.

In each of the power cutters 10, 110, 210 of the first, second, and third embodiments, the distance from the reference plane P to the center of gravity GT of the corresponding power cutter 10, 110, 210 may be less than the width WG of the rear grip 20. According to such a configuration, the posture of the power cutter 10, 110, 210 is easily stabilized when the user holds the power cutter 10, 110, 210 by gripping the rear grip 20, because the center of gravity GT of the power cutter 10, 110, 210 is located closer to the reference plane P of the rear grip 20.

Additionally or alternatively, the distance from the reference plane P to the disk blade 12 may be less than the width WG of the rear grip 20. According to such a configuration, since the disk blade 12 is located even closer to the reference plane P of the rear grip 20, the user can easily hold the power cutter 10, 110, 210 in a stable manner against the reaction force applied to the disk blade 12.

Although the power cutters 10, 110, 210 using the two battery packs 2 are herein described, the power cutters 10, 110, 210 may use three or more battery packs 2, not limited to the two battery packs 2. Each of the plurality of battery packs 2 may have a weight different from one another.

What is claimed is:

1. A power cutter comprising:
a disk blade;
a body configured to rotatably support the disk blade about a rotation axis in front of the body such that the disk blade is located on a reference plane that is perpendicular to the rotation axis,
an electric motor disposed in the body and configured to drive the disk blade;
a front grip and a rear grip disposed on the body and configured to be gripped by a user, the front grip being connected to a front portion of the body and extending across the reference plane above the front portion of the body and the rear grip is connected to a rear portion of the body and extending along the reference plane in rear of the rear portion of the body;
a first battery interface and a second battery interface disposed on a middle portion of the body located between the front portion and the rear portion in a front-rear direction and configured to detachably receive a first batter pack and a second battery pack, respectively; and
a circuitry disposed in the body and configured to electrically connect the first battery pack attached to the first battery interface and the second battery pack attached to the second battery interface to the electric motor,
wherein
the first battery interface is located on one side of the reference plane and comprises a first concavity configured to accommodate the first battery pack such that a center of gravity of the first battery pack is located within the first concavity, and
the second battery interface is located on another side of the reference plane and comprises a second concavity configured to accommodate the second battery pack such that a center of gravity of the second battery pack is located within the second concavity.

2. The power cutter according to claim 1, wherein the first battery interface and the second battery interface are arranged symmetrically with respect to the reference plane.

3. The power cutter according to claim 2, wherein the first concavity of the first battery interface is configured to accommodate an entirety of the first battery pack.

4. The power cutter according to claim 3, wherein the second concavity of the second battery interface is configured to accommodate an entirety of the second battery pack.

5. The power cutter according to claim 4, wherein the body comprises an openable cover configured to cover the first concavity of the first battery interface and the second concavity of the second battery interface.

6. The power cutter according to claim 5, wherein the first battery interface is configured to slidably receive the first battery pack along an up-down direction.

7. The power cutter according to claim 6, wherein the second battery interface is configured to slidably receive the second battery pack along the up-down direction.

8. The power cutter according to claim 7, wherein the up-down direction is perpendicular to the front-rear direction.

9. The power cutter according to claim 8, wherein the up-down direction is parallel to the reference plane.

10. The power cutter according to claim 9, wherein the circuitry is configured to electrically connect the first battery pack and the second battery pack in series.

11. The power cutter according to claim 1, wherein the first battery interface is configured to slidably receive the first battery pack along an up-down direction.

12. The power cutter according to claim 11, wherein the second battery interface is configured to slidably receive the second battery pack along the up-down direction.

13. The power cutter according to claim 12, wherein the up-down direction is perpendicular to the front-rear direction.

14. The power cutter according to claim 13, wherein the up-down direction is parallel to the reference plane.

15. The power cutter according to claim 1, wherein the circuitry is configured to electrically connect the first battery pack and the second battery pack in series.
